(19) United States
(12) Patent Application Publication
(10) Pub. No.: US 2024/0114512 A1
(43) Pub. Date: Apr. 4, 2024

(54) CONTROLLING SHORT CONTROL SIGNALING (SCS) IN UPLINK

(71) Applicant: NOKIA TECHNOLOGIES OY, Espoo (FI)

(72) Inventors: Timo Erkki LUNTTILA, Espoo (FI); Kari Juhani HOOLI, Oulu (FI); Esa Tapani TIIROLA, Oulu (FI)

(21) Appl. No.: 18/257,490

(22) PCT Filed: Dec. 9, 2021
(86) PCT No.: PCT/FI2021/050856

§ 371 Date: Jun. 14, 2023

Related U.S. Application Data
(60) Provisional application No. 63/136,039, filed on Jan. 11, 2021.

(51) Int. Cl. H04W 72/21; H04W 72/0446

(52) U.S. Cl. CPC H04W 72/21; H04W 72/0446

(57) ABSTRACT

Certain example embodiments provide systems, methods, apparatuses, and computer program products for control short control signal (SCS) in uplink. For example, certain embodiments may provide for regulating the amount of uplink (UL) transmissions in a cell, such that SCS limitations are not violated. Certain embodiments may relate to a situation where a single SCS allowance or multiple SCS allowances may be in use in the cell and, e.g., a single SCS allowance may be shared between a gNB and the UEs, or a single SCS allowance may be shared between the UEs.

### CROSS-REFERENCE TO RELATED APPLICATION

This application is related to and claims the benefit and priority of U.S. Provisional Patent Application No. 63/136,039, filed Jan. 11, 2021, the entirety of which is hereby incorporated by reference.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for controlling short control signaling (SCS) in uplink.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

According to a first embodiment, a method may include transmitting an indication of an allowance of time or resources of a time period for one or more short control signals. The one or more short control signals may be associated with one or more signals or channels. The method may include receiving a transmission of the one or more short control signals based on the indication.

In a variant, the allowance of time or resources may comprise slots or symbols associated with the time period. In a variant, the allowance of time or resources may comprise a portion of time of the time period. In a variant, the allowance of time or resources may be shared between one or more user equipment, the network node, or one or more network nodes. In a variant, the method may further include determining an amount of the allowance that has been consumed after transmitting the one or more short control signals, and transmitting information that identifies the amount of the allowance that has not been consumed or an updated allowance. In a variant, the method may further include transmitting one or more downlink signals as one or more short control signals.

According to a second embodiment, a method may include determining that one or more signals or channels can be transmitted as one or more short control signals. The method may include receiving an indication of an allowance of time or resources of a time period for the one or more short control signals. The method may include determining whether to transmit at least one of the one or more signals or channels as one or more short control signals based on a type of the one or more signals or channels and on the allowance. The method may include transmitting the one or more short control signals.

In a variant, the determining that the one or more signals or channels can be transmitted may comprise determining that at least one of the one or more signals or channels is of a type that can be transmitted as the one or more short control signals without regard to the allowance, or determining that at least one of the one or more signals or channels is of one or more other types that can be transmitted as the one or more short control signals according to the allowance. In a variant, the allowance of time or resources may comprise slots or symbols associated with the time period. In a variant, the allowance of time or resources may comprise a portion of time of the time period. In a variant, the allowance of time or resources may be shared between the user equipment and at least one or more other user equipment or one or more network nodes.

In a variant, the determining of whether to transmit may include determining that the one or more signals or channels are of a type of that can be transmitted as the one or more short control signals, and determining that the allowance has not been exceeded. In a variant, the determining of whether to transmit may include determining that the allowance has been exceeded, and based on performing a listen-before-talk procedure, transmitting the one or more short control signals if a channel is free. In a variant, the method may further include determining an amount of the allowance that has been consumed after transmitting the one or more short control signals.

In a variant, the method may further include receiving one or more downlink signals or channels. At least one of the one or more signals or channels that can be transmitted as the one or more short control signals may comprise the one or more downlink signals or channels. In a variant, the indicated allowance of time or resources may include resources following an end of an indicated channel occupancy time, or the indication may be valid for a predetermined time after the end of the indicated channel occupancy time. In a variant, the method may further include receiving an indication of a portion of the allowance of the time or resources, determining that at least one of the one or more signals or channels is of a type that can be transmitted as the one or more short control signals according to the allowance, and determining that at least one of the one or more signals or channels is of one or more other types that can be transmitted as the one or more short control signals according to the allowance and the portion of the allowance.

A third embodiment may be directed to an apparatus including at least one processor and at least one memory comprising computer program code. The at least one memory and computer program code may be configured, with the at least one processor, to cause the apparatus at least to perform the method according to the first embodiment or the second embodiment, or any of the variants discussed above.

A fourth embodiment may be directed to an apparatus that may include circuitry configured to cause the apparatus to perform the method according to the first embodiment or the second embodiment, or any of the variants discussed above.

A fifth embodiment may be directed to an apparatus that may include means for performing the method according to the first embodiment or the second embodiment, or any of the variants discussed above. Examples of the means may include one or more processors, memory, and/or computer program codes for causing the performance of the operation.

A sixth embodiment may be directed to a computer readable medium comprising program instructions stored thereon for causing an apparatus to perform at least the method according to the first embodiment or the second embodiment, or any of the variants discussed above.

A seventh embodiment may be directed to a computer program product encoding instructions for causing an apparatus to perform at least the method according to the first embodiment or the second embodiment, or any of the variants discussed above.

### BRIEF DESCRIPTION OF THE DRAWINGS

For proper understanding of example embodiments, reference should be made to the accompanying drawings, wherein:

FIG. 1 illustrates an example of controlling SCS in uplink, according to some embodiments;

FIG. 2 illustrates another example of controlling SCS in uplink, according to some embodiments;

FIG. 3 illustrates an example flow diagram of a method, according to some embodiments;

FIG. 4 illustrates an example flow diagram of a method, according to some embodiments;

FIG. 5a illustrates an example block diagram of an apparatus, according to an embodiment; and

FIG. 5b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for controlling SCS in uplink is not intended to limit the scope of certain embodiments but is representative of selected example embodiments.

The features, structures, or characteristics of example embodiments described throughout this specification may be combined in any suitable manner in one or more example embodiments.

For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Certain regulations for operation on 60 gigahertz (GHz) unlicensed spectrum may use a spectrum sharing or co-channel coexistence mechanism, but specifications may not provide for any specific type of a mechanism. In some regions, separate specifications may be defined for different use cases or deployments (e.g., for fixed outdoor equipment or point-to-point communications or for indoor-only use). Some specifications may provide for the use of listen-before-talk (LBT) as well as without LBT on 60 GHz.

NR may provide for SCS for unlicensed spectrum operation at the frequency range from 53.6 GHz to 71 GHz. For example, NR may support contention-exempt SCS transmission in the 60 GHz band for regions where LBT is needed and SCS without LBT is allowed. If regulations do not allow SCS exemption in a region when operating with LBT, operation with LBT for these SCSs may be supported. Restrictions to the transmission, such as on duty cycle (airtime measured over a relatively long period of time), content, transmit (TX) power, etc. may be provided for by NR.

One scenario for SCS usage may include transmission of synchronization signal block (SSB) or discovery reference signals (DRS) by the gNB. Depending on the SSB periodicity, the amount of SCS used for each 100 millisecond (ms) window may vary. The total time (ms) needed to convey 4-symbol periodical SSB for 64 beams during 100 ms windows may be indicated. The allowance (e.g., 10 ms) may exceed the total time needed for periodical SSBs. The remaining portion of the 10 ms allowance may be available, e.g., for uplink (UL) SCS (provided that downlink (DL) signals may consume the same SCS budget). The duration for a 100 ms window for a 4-symbol SSB (120 kHz SCS or 240 kHz SCS) may scale down with the number of SSB beams used.

Based on this, the SCS allowance of 10 percent (%) over a 100 ms observation interval can be used for various types of control and management transmissions. SCS transmissions may not need to be periodic. Multiple SCS transmissions may be allowed within the 100 ms observation interval as long as the 10% limit is not exceeded. For the SCS, each device (UE and gNB) in a cell may be allowed to transmit SCS up to 10% of the time. In the case of a cellular system and several UEs attached to cell, this may result in a significant amount of SCS transmissions.

In NR, there may be a scenario where a predefined portion of time can be used for LBT-exempt (SCS) transmissions in a cell. In some cases, the portion of time (e.g., 10% out of 100 ms) is shared among multiple devices. The LBT-exempt portion of time may be either common for DL and UL transmissions on the cell (e.g., the gNB and the UEs in the cell), or used just for UL transmissions (in which case, the gNB may use separate 10% SCS allowance for DL transmissions). In this scenario, it may be unclear how to manage the UL transmission by different UEs such that the limit for the maximum amount of SCS transmissions is not exceed (while maximizing the usage of the SCS allowance). UEs may use SCS allowance for various types of transmissions, including, e.g., hybrid automatic repeat request acknowledgement (HARQ-ACK), channel state information (CSIs) reports, and scheduling requests (SRs) on physical uplink control channel (PUCCH) or physical uplink shared channel (PUSCH), sounding reference signals (SRSs), physical random access channel (PRACH) preambles and other messages related to random access procedures, etc. Some of these signals may be dynamically scheduled with downlink control information (DCI), and their transmissions can be accurately controlled by the gNB, but others may also be configured semi-statically and transmitted on a per-need basis, which may make it difficult for the network to ensure that the 10% allowance for SCS transmissions is not exceeded.

Transmitting selected signals and/or channels as SCS transmissions may be useful as 1) the signals may be critical for communications; 2) deterministic transmission time of the signals may be maintained when the channel access uncertainty is removed; and 3) there may be no need to modify, e.g., signal design to facilitate the time gap for LBT measurements.

Some embodiments described herein may provide for controlling SCS in uplink. For example, certain embodiments may provide for regulating the amount of UL transmissions in a cell, such that SCS limitations are not violated. Certain embodiments may relate to a situation where a single SCS allowance or multiple SCS allowances (e.g., 10 ms during a 100 ms observation interval) may be in use in the cell and, e.g., a single SCS allowance may be shared between a gNB and the UEs, or a single SCS allowance may be shared between the UEs (while the gNB is using another SCS allowance). Alternatively, each UE connected to a gNB may have a dedicated SCS allowance, that may be shared with the gNB.

Certain embodiments may provide a mechanism for controlling the SCS transmissions (e.g., LBT-exempt transmissions) in the UL so that the SCS allowance shared between multiple devices is not exceeded. The network may control (e.g., configures or indicates) to a UE whether UL SCS transmissions can be used on a cell. The signals and/or channels (such as PRACH, SR, link recovery request (LRR), sounding reference signal (SRS), CSI or layer 1-reference signal received power (L1-RSRP) reports, an acknowledgement or negative acknowledgement (A/N)) that can be transmitted as SCS transmissions may be predetermined and/or configured to the UE (e.g., it may be predefined that PRACH may be transmitted as an SCS when enabled, and the UE may receive configuration of further signals for SCS transmissions). The network may also control the portion of time (e.g., 1 ms during a 100 ms observation interval, or 50 microsecond (us) during a 5 ms interval, or a corresponding percentage of time within an observation interval) that the UE can use for SCS transmissions. The portion of time may be the UE's share of the overall SCS allowance in the cell.

The controlling may be performed via radio resource control (RRC) signalling, or with a medium access control element (MAC CE), or via DCI (e.g., group common PDCCH (GC-PDCCH), such as DCI format 2_0). A device may control that the UE's portion of time allowed for SCS transmissions is not exceed. For that purpose, the device may perform dynamic record-keeping on the signals transmitted as part of the portion of time allowed for SCS transmissions over a certain time interval. Depending on the scenario, the recording-keeping device may be either a UE or a gNB (or a central unit (CU) or a distributed unit (DU) of the gNB). When the portion of time allowed for SCS transmissions is fully used (exhausted) for the interval, the UE may perform LBT prior to a UL transmission or may transmit the signal and/or channel when the transmission occasion occurs during a gNB initiated channel occupancy time (COT). A COT may include a gNB-initiated COT and may include UL transmissions. In certain embodiments, the UL signals transmitted during a COT without channel sensing or LBT at the UE (e.g., based on category 1 (Cat-1) channel access) may not be included in the portion of time (e.g., may not consume the SCS allowance for a certain observation interval). This may allow further opportunities for transmission of UL signals as SCSs. The UE may receive information about the COT via GC-PDCCH.

In some example embodiments, the device controlling the UE's portion of time for SCS transmission may be a network entity such as gNB, CU, or DU. The UE's portion of SCS transmission in time can also be controlled dynamically over the time interval. This can be achieved by the network entity providing an indication of a temporal allowance for UL SCS transmissions. The indication can be transmitted to the UE(s) via GC-PDCCH, DCI, or MAC-CE. The temporal allowance may allow LBT-exempt transmission for the configured UL signals with related constraints. Temporal allowance may be defined such that it covers certain (undefined) resources within a certain time window.

With respect to certain constraints, the time window can be pre-defined, configured, and/or indicated, e.g., using GC-PDCCH. The time window may be defined with respect to a COT, e.g., a window starting after the end of the COT. The time window may also be longer and may cover multiple COTs. Additionally, or alternatively, with respect to certain constraints, temporal allowance may be constrained by the resource type. For example, it may cover resources indicated by the slot format indication (SFI) in GC-PDCCH as flexible or UL resources (or also the resources that are undefined) within a predefined/indicated time window after the COT (but not DL resources). Additionally, or alternatively, with respect to the constraints, the temporal allowance may be further restricted to a maximum number of transmissions by a single UE per each time window. Additionally, or alternatively, with respect to the constraints, the temporal allowance may be limited to certain beams or transmission directions (e.g., ones that are associated or quasi-co-located with the gNB beam via which the indication of allowance was provided). Signals allowed for SCS transmissions may be categorized (e.g., predefined or configured) in one or more types (e.g., a first type and a second type). The SCS transmission may be used consistently for the first type of signals. The first type of signals may include UL signals, such as PRACH. The UE may transmit the first type of signals as SCS transmissions once it is determined that SCS transmissions are allowed (e.g., PRACH during initial access). Transmission of the second type of signals as SCS transmissions may be conditioned upon the temporal allowance. The second type of signals can also be divided into multiple groups with the group-specific temporal allowance. The categorization can be performed, e.g., per channel or signal.

In other example embodiments, the device controlling the UE's portion of time may be the UE itself. The UE's portion of time for SCS transmission over a time interval may be indicated to the UE by a gNB via an RRC configuration, MAC CE, or DCI (e.g., GC-PDCCH). The SCS UL transmissions may be categorized into one or more types of signals. The configuration may include a first allowance and possibly a second, third, etc. allowance for SCS transmissions. The second, third, etc. allowances may be a portion of the first allowance. The UE may control that the portion of time allowed for SCS transmissions is not exceed by a first counter and also by second, third, etc. counters that are set to zero periodically (e.g., every 100 ms). Additionally, or alternatively, the UE may control that the transmitted first type of signals are counted for the first counter except when transmitted during a COT without channel sensing or without an LBT at the UE. In this case, SCS transmissions may be halted for the first type of signals if the first counter reaches the first allowance (or zero, if the counter is counting down). Additionally, or alternatively, the UE may perform the control by the transmitted second, third, etc. types of signals, if present, being counted for both first and second, third, etc. counters except when transmitted during a COT without channel sensing or with an LBT at the UE. In this case, SCS transmissions may be halted for second, third, etc. types of signals if the first counter reaches the first allowance or if the second, third, etc. counters exceed the second, third, etc. allowance, respectively.

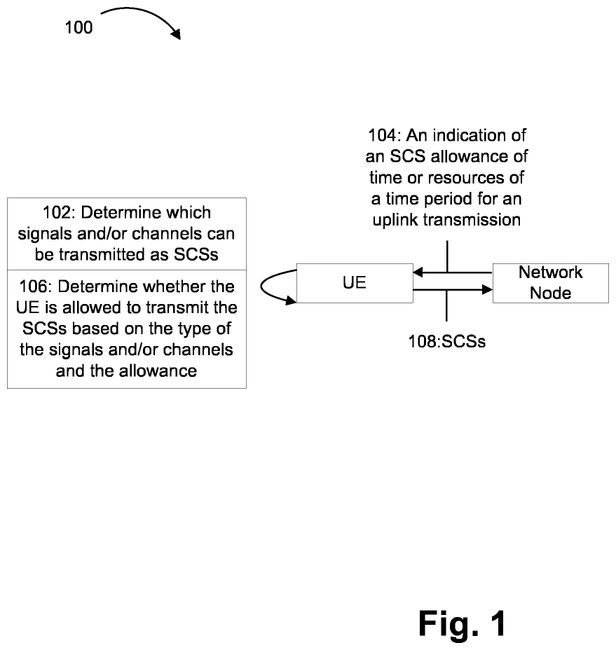

FIG. 1 illustrates an example 100 of controlling SCS in uplink, according to some embodiments. As illustrated in FIG. 1, the example 100 includes a UE and a network node (e.g., a gNB).

As illustrated at 102, the UE may determine which signals and/or channels can be transmitted as SCSs. For example, the UE may determine which signals and/or channels are of the first type, or are of the second, third, fourth, etc. type (e.g., where the first type of signals can be transmitted as SCSs without regard to an SCS allowance and the second, third, etc. types can be transmitted as SCSs if there is an SCS allowance available). The determination may be predetermined and fixed (e.g., preconfigured in the UE or set by standards). For example, there may be one type of signal, including various UL control transmissions, such as HARQ-ACK, CSI, SR, SRS, or RACH. Alternatively, the first type of signals may include RACH signals, while other UL control signals may be one or more other type (e.g., the second, third, etc. types). Alternatively, the first type may include RACH, while other UL control signals configured to operate according to SCS rules may be either in the first or second type according to the configuration. Alternatively, the signals belonging to first or to the second, third, etc. types may be configured with RRC signalling, channel-by-channel.

As illustrated at 104, the UE may receive, from the network node, an indication of an SCS allowance of time or resources of a time period for a UL transmission (e.g., a type of UL transmission described above). In some embodiments, the indication may include an indication of the resources (e.g., slots or symbols), in which the UE is allowed to transmit an SCS. The indication can be transmitted to the UE(s) via GC-PDCCH or another DCI. The indicated resources may be the ones following the end of the indicated channel occupancy time. The indicated resources may further be restricted to be the ones that are indicated to be UL or flexible resources, or where the type is undefined. The indication may be valid for a predetermined time after the indicated end of the COT.

In some embodiments, the indication may include an indication of the portion of time that the UE may use for its SCS transmissions during a predetermined time window (e.g., 100 ms). This indication may be in the unit of symbols or group of symbols (e.g., mini-slots) or slots. Alternatively, this indication may be given as a percentage, e.g., 5% of 100 ms. The indication may be carried via an RRC configuration, MAC CE, or DCI (e.g., GC-PDCCH).

As illustrated at 106, the UE may determine whether the UE is allowed to transmit the SCSs based on the type of the signals and/or channels and the allowance and may, at 108, transmit the SCSs to the network node. For example, the UE may determine whether it is allowed to transmit SCSs for UL signals that are of the second, third, fourth, etc. types. In some embodiments, the determination based on the allowance may be based on the indicated resources. Additionally, or alternatively, this determination may be based on the indication of the portion of time that the UE may use for its SCS transmissions. In this case, the UE may initiate a counter for UL transmissions of each type (e.g., first, second, third, etc.). The counter(s) may be set initially to either ‘0’ or a number corresponding to the number of transmissions allowed. Upon an SCS UL transmission of a given type, the UE may record the number of SCS transmissions and/or durations of the SCS transmissions that have taken place during the predetermined time window. If the number of SCS transmissions during the predetermined time window exceeds the SCS allowance (for a certain type of UL transmission) further SCS transmissions may not be allowed during the time window.

As described above, FIG. 1 is provided as an example. Other examples are possible, according to some embodiments.

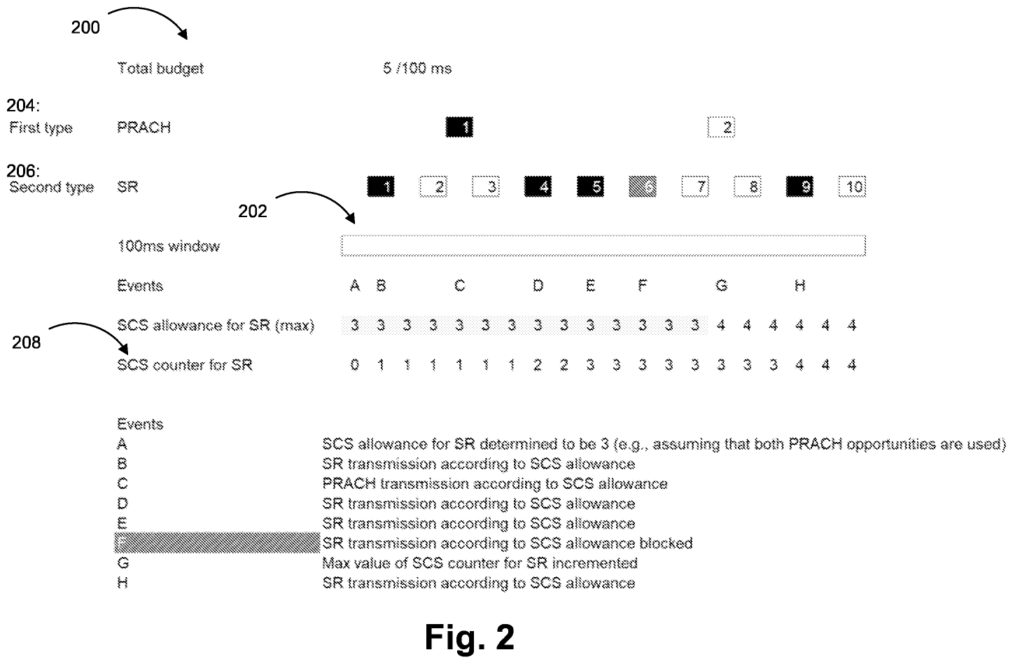

FIG. 2 illustrates an example 200 of controlling SCS in uplink, according to some embodiments. As illustrated in FIG. 2, a predetermined time window 202 for SCS may be 100 ms, and the total SCS allowance for the UE may be 5 PRACH and/or SR transmissions (of predefined length). The number of transmissions may be derived from the SCS allowance and the PRACH and SR durations. PRACH and SR may be assumed to have the same duration. In the example 200, various types of UL signals may be defined. For example, there may be a first type of signal 204, such as a PRACH, which may be transmitted as SCS without restriction. As another example, there may be a second type of signal 206, such as a SR, that can be transmitted as SCS if there is room in the allowance in the SCS window after the first type (PRACH) transmissions.

The UE may maintain a counter 208 for SCS transmissions. For example, the counter may record events A, B, C, D, E, F, G, and H in FIG. 2. For event A, the SCS counter 208 for the SR transmissions may be determined to be 3 (as both PRACH opportunities within the window may be used (e.g., 5−2=3)). Event B may comprise a SR transmission according to the SCS allowance, and the SCS counter for the SR transmissions may be incremented by 1 to a value of 1. Event C may comprise a PRACH transmission according to the SCS allowance. Event D may comprise an SR transmission according to the SCS allowance, and the SCS counter 208 may be incremented by 1 to a value of 2. Event E may comprise an SR transmission according to the SCS allowance, and the SCS counter 208 for SR signals may be incremented by 1 to a value of 3. Event F may comprise a SR transmission that is not transmitted because the SCS counter may have been incremented to the maximum value of the SCS allowance. At event G, the maximum value of the SCS counter 208 for SR transmissions is incremented and the PRACH is not transmitted. Since the PRACH is not transmitted, one transmission is released from the PRACH SCS allowance to the SR SCS allowance. Event H may comprise a SR transmission according to the SCS allowance, and the SCS counter 208 for SR may be incremented by 1 to a value of 4.

As indicated above, FIG. 2 is provided as an example. Other examples are possible, according to some embodiments.

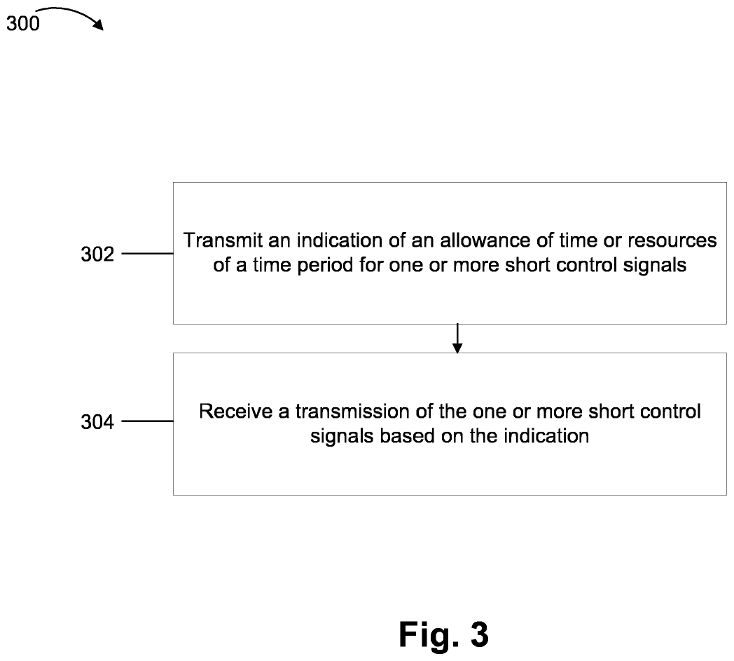

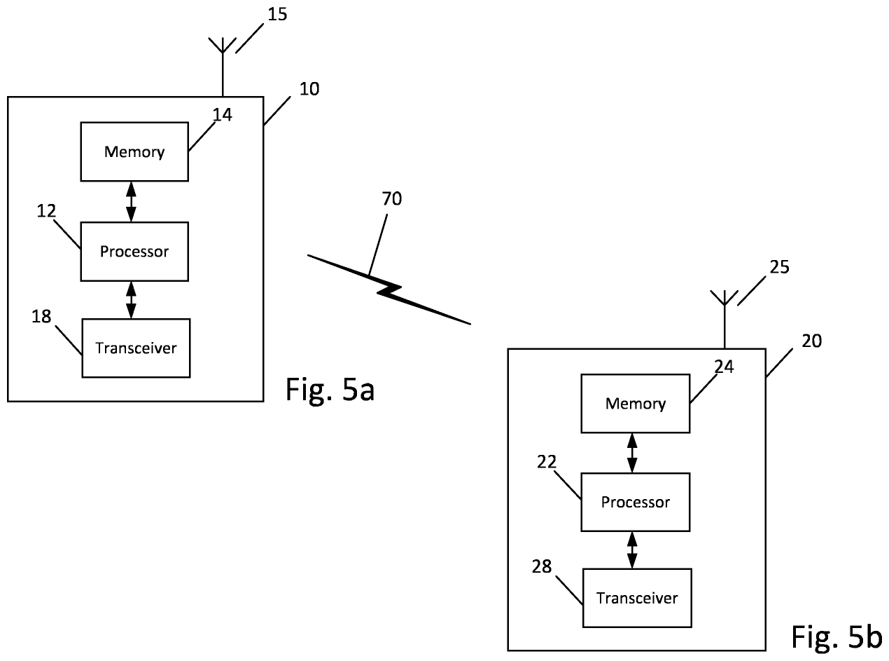

FIG. 3 illustrates an example flow diagram of a method 300, according to some embodiments. For example, FIG. 3 may illustrate example operations of a network node (e.g., apparatus 10 illustrated in, and described with respect to, FIG. 5a). Some of the operations illustrated in FIG. 3 may be similar to some operations shown in, and described with respect to, FIGS. 1 and 2.

In an embodiment, the method may include, at 302, transmitting an indication of an allowance of time or resources of a time period for one or more short control signals, for example, in a manner similar to that at 104 of FIG. 1. The one or more short control signals may be associated with one or more signals or channels. The method may include, at 304, receiving a transmission of the one or more short control signals based on the indication, for example, in a manner similar to that at 108 of FIG. 1.

The method illustrated in FIG. 3 may include one or more additional aspects described below or elsewhere herein. In some embodiments, the allowance of time or resources may comprise slots or symbols associated with the time period. In some embodiments, the allowance of time or resources may comprise a portion of time of the time period. In some embodiments, the allowance of time or resources may be shared between one or more user equipment, the network node, or one or more network nodes. In some embodiments, the method may further include determining an amount of the allowance that has been consumed after transmitting the one or more short control signals, and transmitting information that identifies the amount of the allowance that has not been consumed or an updated allowance. In some embodiments, the method 300 may further include transmitting one or more downlink signals as one or more short control signals. For example, the network node may transmit one or more downlink signals as SCSs (in addition to receiving UL transmissions from the UE). The downlink signals transmitted as SCSs may reduce the amount of signals that the UE can transmit as SCSs.

As described above, FIG. 3 is provided as an example. Other examples are possible according to some embodiments.

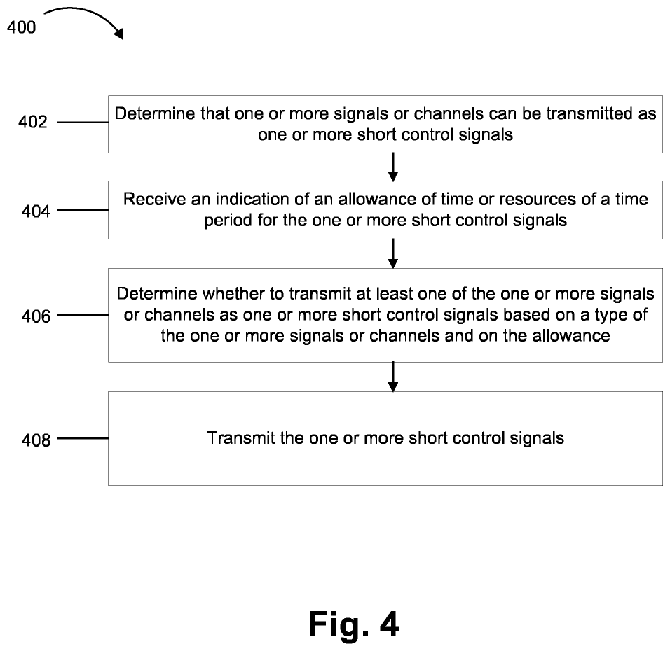

FIG. 4 illustrates an example flow diagram of a method 400, according to some embodiments. For example, FIG. 4 may illustrate example operations of a UE (e.g., apparatus 20 illustrated in, and described with respect to, FIG. 5b). Some of the operations illustrated in FIG. 4 may be similar to some operations shown in, and described with respect to, FIGS. 1 and 2.

In an embodiment, the method may include, at 402, determining that one or more signals or channels can be transmitted as one or more short control signals, for example, in a manner similar to that at 102 of FIG. 1. The method may include, at 404, receiving an indication of an allowance of time or resources of a time period for the one or more short control signals, for example, in a manner similar to that at 104 of FIG. 1. The method may include, at 406, determining whether to transmit at least one of the one or more signals or channels as one or more short control signals based on a type of the one or more signals or channels and on the allowance, for example, in a manner similar to that at 106 of FIG. 1. The method may include, at 408, transmitting the one or more short control signals, for example, in a manner similar to that at 108 of FIG. 1.

The method illustrated in FIG. 4 may include one or more additional aspects described below or elsewhere herein. In some embodiments, the determining at 402 may comprise determining that at least one of the one or more signals or channels is of a type that can be transmitted as the one or more short control signals without regard to the allowance, or determining that at least one of the one or more signals or channels is of one or more other types that can be transmitted as the one or more short control signals according to the allowance. In some embodiments, the allowance of time or resources may comprise slots or symbols associated with the time period. In some embodiments, the allowance of time or resources may comprise a portion of time of the time period. In some embodiments, the allowance of time or resources may be shared between the user equipment and at least one or more other user equipment or one or more network nodes.

In some embodiments, the determining at 406 may include determining that the one or more signals or channels are of a type of that can be transmitted as the one or more short control signals, and determining that the allowance has not been exceeded. In some embodiments, the determining at 406 may include determining that the allowance has been exceeded, and based on performing a listen-before-talk procedure, transmitting the one or more short control signals if a channel is free. In some embodiments, the method 400 may further include determining an amount of the allowance that has been consumed after transmitting the one or more short control signals.

In some embodiments, the method 400 may further include receiving one or more downlink signals or channels. At least one of the one or more signals or channels that can be transmitted as the one or more short control signals may comprise the one or more downlink signals or channels. In some embodiments, the indicated allowance of time or resources may include resources following an end of an indicated channel occupancy time, or the indication may be valid for a predetermined time after the end of the indicated channel occupancy time. In some embodiments, the method 400 may further include receiving an indication of a portion of the allowance of the time or resources, determining that at least one of the one or more signals or channels is of a type that can be transmitted as the one or more short control signals according to the allowance, and determining that at least one of the one or more signals or channels is of one or more other types that can be transmitted as the one or more short control signals according to the allowance and the portion of the allowance. For example, the first type of signals or channels may consume the whole allowance, while the second type of signals or channels may consume a portion of the allowance but may have to have some allowance remaining in order to be transmitted (e.g., due to the first type of signals or channels).

As described above, FIG. 4 is provided as an example. Other examples are possible according to some embodiments.

FIG. 5a illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G. In some example embodiments, apparatus 10 may be a relay node, such as an integrated access and backhaul (IAB) node. In the IAB scenario, gNB operations may be performed by a distributed unit (DU), and UE operations may be performed by a mobile termination (MT) part of the IAB node.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 5a.

As illustrated in the example of FIG. 5a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5a, multiple processors may be utilized according to other embodiments. For example, it should be understood that, in certain embodiments, apparatus may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like.

According to certain embodiments, apparatus 10 may be controlled by memory 14 and processor 12 to perform the functions associated with any of the embodiments described herein, such as some operations illustrated in, or described with respect to, FIGS. 1-4. For instance, apparatus 10 may be controlled by memory 14 and processor 12 to perform the method of FIG. 3.

FIG. 5b illustrates an example of an apparatus 20 according to another embodiment. In an embodiment, apparatus 20 may be a node or element in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5b.

As illustrated in the example of FIG. 5b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with any of the embodiments described herein, such as some operations illustrated in, or described with respect to, FIGS. 1-4. For instance, in one embodiment, apparatus 20 may be controlled by memory 24 and processor 22 to perform the method of FIG. 4.

In some embodiments, an apparatus (e.g., apparatus 10 and/or apparatus 20) may include means for performing a method or any of the variants discussed herein, e.g., a method described with reference to FIG. 4 or 5. Examples of the means may include one or more processors, memory, and/or computer program code for causing the performance of the operation.

Therefore, certain example embodiments provide several technological improvements, enhancements, and/or advantages over existing technological processes. For example, one benefit of some example embodiments is control of which UL transmissions are transmitted as SCSs when an SCS allowance is shared between multiple devices, which may help to ensure that the aggregated amount of SCS transmissions with a cell remains within acceptable limits from the perspective of co-existence with other systems. Accordingly, the use of some example embodiments results in improved functioning of communications networks and their nodes and, therefore constitute an improvement at least to the technological field of UL SCS transmissions, among others.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

A/N Acknowledgement/Negative acknowledgement
BW Bandwidth
CORESET Control Resource Set
COT Channel Occupancy Time
CU Central Unit
DCI Downlink Control Information
COT Channel Occupancy Time
CSI Channel State Information
CSI-RS Channel state information—reference symbols
DL Downlink
DRS Discovery Reference Signal
DU Distributed Unit
FR2 Frequency Range 2
gNB New Radio Node B
GC Group common
HARQ-ACK Hybrid Automatic Repeat Request Acknowledgement
L1 Layer 1
LAA License Assisted Access
LBT Listen-Before-Talk
LRR Link Recovery Request
LTE Long Term Evolution
MAC-CE Medium access control—control element
NR New Radio
NR-U New Radio Unlicensed
PDCCH Physical Downlink Control Channel
PDSCH Physical Downlink Shared Channel
PUCCH Physical Uplink Control Channel
PUSCH Physical Uplink Shared Channel
RACH Random Access Channel
RSRP Reference Signal Received Power
RRC Radio Resource Control
Rx Receive
SCS Short Control Signalling
SFI Slot Format Indicator
SR Scheduling Request
SRS Sounding Reference Signal
SSB Synchronization Signal Block
Tx Transmit
UE User Equipment
UL Uplink

1-85. (canceled)

86. An apparatus, comprising:
at least one processor; and
at least one memory comprising computer program code,
the at least one memory and computer program code configured, with the at least one processor, to cause the apparatus at least to:
determine that one or more signals or channels can be transmitted as one or more short control signals;
receive an indication of an allowance of time or resources of a time period for the one or more short control signals;
determine whether to transmit at least one of the one or more signals or channels as one or more short control signals based on a type of the one or more signals or channels and on the allowance; and
transmit the one or more short control signals.

87. The apparatus according claim 86, wherein the at least one memory and the computer program code are configured to, with the at least one processor, further cause the apparatus, when determining that the one or more signals or channels can be transmitted, at least to:
determine that at least one of the one or more signals or channels is of a type that can be transmitted as the one or more short control signals without regard to the allowance, or
determine that at least one of the one or more signals or channels is of one or more other types that can be transmitted as the one or more short control signals according to the allowance.

88. The apparatus according to claim 86, wherein the allowance of time or resources comprises slots or symbols associated with the time period.

89. The apparatus according to claim 86, wherein the allowance of time or resources comprises a portion of time of the time period.

90. The apparatus according to claim 86, wherein the allowance of time or resources is shared between the apparatus and at least one or more other apparatuses or one or more network nodes.

91. The apparatus according to claim 86, wherein the at least one memory and the computer program code are configured to, with the at least one processor, further cause the apparatus, when determining whether to transmit, at least to:
determine that the one or more signals or channels are of a type of that can be transmitted as the one or more short control signals; and
determine that the allowance has not been exceeded.

92. The apparatus according to claim 86, wherein the at least one memory and the computer program code are configured to, with the at least one processor, when determining whether to transmit, cause the apparatus at least to:
determine that the allowance has been exceeded; and
based on performing a listen-before-talk procedure, transmit the one or more short control signals if a channel is free.

93. The apparatus according to claim 86, wherein the at least one memory and the computer program code are configured to, with the at least one processor, further cause the apparatus at least to:
determine an amount of the allowance that has been consumed after transmitting the one or more short control signals.

94. The apparatus according to claim 86, wherein the at least one memory and the computer program code are configured to, with the at least one processor, further cause the apparatus at least to:
receive one or more downlink signals or channels, wherein at least one of the one or more signals or channels that can be transmitted as the one or more short control signals comprises the one or more downlink signals or channels.

95. The apparatus according to claim 86, wherein the indicated allowance of time or resources comprises resources following an end of an indicated channel occupancy time, or
wherein the indication is valid for a predetermined time after the end of the indicated channel occupancy time.

96. The apparatus according to claim 86, wherein the at least one memory and the computer program code are configured to, with the at least one processor, further cause the apparatus at least to:
receive an indication of a portion of the allowance of the time or resources;
determine that at least one of the one or more signals or channels is of a type that can be transmitted as the one or more short control signals according to the allowance; and
determine that at least one of the one or more signals or channels is of one or more other types that can be transmitted as the one or more short control signals according to the allowance and the portion of the allowance.

97. A method, comprising:
determining that one or more signals or channels can be transmitted as one or more short control signals;
receiving an indication of an allowance of time or resources of a time period for the one or more short control signals;
determining whether to transmit at least one of the one or more signals or channels as one or more short control signals based on a type of the one or more signals or channels and on the allowance; and
transmitting the one or more short control signals.

98. The method according claim 97, wherein the determining that the one or more signals or channels can be transmitted further comprises:
determining that at least one of the one or more signals or channels is of a type that can be transmitted as the one or more short control signals without regard to the allowance, or
determining that at least one of the one or more signals or channels is of one or more other types that can be transmitted as the one or more short control signals according to the allowance.

99. The method according to claim 97, wherein the allowance of time or resources comprises slots or symbols associated with the time period.

100. The method according to claim 97, wherein the allowance of time or resources comprises a portion of time of the time period.

101. The method according to claim 97, wherein the allowance of time or resources is shared between the apparatus and at least one or more other apparatuses or one or more network nodes.

102. The method according to claim 97, wherein the determining whether to transmit further comprises:
determining that the one or more signals or channels are of a type of that can be transmitted as the one or more short control signals; and
determining that the allowance has not been exceeded.

103. The method according to claim 97, wherein the determining whether to transmit further comprises:
determining that the allowance has been exceeded; and
based on performing a listen-before-talk procedure, transmitting the one or more short control signals if a channel is free.

104. The method according to claim 97, further comprising:
determining an amount of the allowance that has been consumed after transmitting the one or more short control signals.

105. A non-transitory computer-readable medium encoded with instructions that, when executed by a processor, cause an apparatus to at least:
determine that one or more signals or channels can be transmitted as one or more short control signals;
receive an indication of an allowance of time or resources of a time period for the one or more short control signals;
determine whether to transmit at least one of the one or more signals or channels as one or more short control signals based on a type of the one or more signals or channels and on the allowance; and
transmit the one or more short control signals.
